(19) United States
(12) Patent Application Publication
(10) Pub. No.: US 2020/0090264 A1
(43) Pub. Date: Mar. 19, 2020

(54) Credit Optimization Platform

(71) Applicant: Affordability4You, Inc., Tampa, FL (US)

(72) Inventor: Kevin O'Brien, Tampa, FL (US)

(21) Appl. No.: 16/134,032

(22) Filed: Sep. 18, 2018

(51) Int. Cl. G06Q 40/02; G06Q 40/08

(52) U.S. Cl. CPC G06Q 40/025; G06Q 40/08

(57) ABSTRACT

A system for credit optimization first attempts to originate the requested loan through standard practices, but if the consumer is denied, the system for credit optimization analyzes the consumer's financial situation and, if possible, makes recommendations that, if accepted, will move the consumer's financial state into one in which the loan will likely be approved. Although many alternatives are anticipated for use by the system for credit optimization, a few examples are looking for refinance options to reduce existing debt, looking to existing assets for equity, looking to see if there are co-consumers and whether one of the co-consumers is in a better financial state and is able to obtain the loan without the other co-consumer, etc.

### FIELD

This invention relates to the field of finances and more particularly to a system for optimizing customer's debt liabilities, for example when seeking a loan of any type.

### BACKGROUND

People and businesses often have a complicated collection of assets and liabilities such as property, vehicles, student loans, mortgages, vehicle loans, cash, etc. With respect to liabilities (e.g. money that is owed to another), without careful reconsideration periodically, it is difficult to understand where improvements are possible. For example, if one has a credit card balance and is paying 17% interest but has equity in a motor vehicle on which a lower rate auto loan exists (e.g. 5%). It is possible that the auto can be modified to extract some or all of the equity and the proceeds be used to pay down or pay off the credit card debt. Most do not look for such opportunities and even if they do, the financial opportunities that are available are often too complicated for most to understand, so such opportunities go unfound.

One need for such analysis is when a loan is sought. People and businesses apply for loans every day. Lending establishments review loan applications and decide whether the applicant qualifies for the requested loan based upon many different factors. One primary factor that is used by many or all lending establishments is debt-to-income ratio. The debt-to-income ratio is a calculation of the portion of a person's, families', or business's income that is allocated to paying off debt. Acceptable debt-to-income ratios vary based upon lending establishments, as some lending establishments are willing to take on more risk (e.g. they are willing to lend to those with a higher debt-to-income ratio). Debt-to-income ratio has been demonstrated as a good measurement of a lender's ability to repay a loan. As one might imagine, if a lender's debt-to-income ratio is close to 100%, it would be almost impossible for that consumer to pay back their debts as the consumer also needs money for food, clothing, transportation, etc.

The debt-to-income ratio takes into account all loans/debts of the applicant, typically through review of one or more credit reports pulled by the lender. One example is a couple seeking to obtain a mortgage loan. The lender pulls a credit report for both applicants and finds that both are repaying student loans, one having $3,000 due with payments of $100.00 per month and the other having $1,000 due with payments of $200.00 per month. The lender also finds that there is a car loan with payments of $200.00 per month. The couple has a total income of $81,600.00 per year, or $6,800.00 per month. This couple seeks to buy a home in the amount of $225,000.00. Having a $25,000.00 down payment, the couple plans to obtain a 30-year mortgage loan in the amount of $200,000.00. At current interest rates would require payments of $1,200.00 per month. Therefore, this couple having $6,800.00 per month in income will have $1,700.00 ($100.00+$200.00+$200.00+$1200.00) in loan payments per month, or a debt-to-income ratio of 25%. In this case, the lender finds the debt-to-income ratio acceptable and approves the loan.

In another example similar to the above, the same couple has the same existing student and car loans and seeks the same mortgage loan, but the couple earns less, having a total income of $40,800.00 per year, or $3,400.00 per month. The interest payment of $1,700.00 in loan payments per month, if approved, will increase this couple's debt-to-income ratio to around 50%. Most lenders will not approve a loan with such a high debt-to-income ratio, and this loan is not approved. The couple receives a letter simply stating that their loan is not approved. The loan originator does not look for alternatives

If the couple reallocated some of their down payment to pay off their student loans, the total mortgage amount would increase by $4,000.00 to $204,000.00, and the monthly mortgage payments would increase slightly to $1,224 and the total monthly payments would be $1,424.00 ($200.00+$1,224.00) instead of $1,700.00. This reduces the couple's debt-to-income ratio from 50% to around 34%, which is then accepted and their loan is approved.

What is needed is a system that will automatically analyze alternative strategies for optimizing debt liabilities and, therefore, credit.

### SUMMARY

A system for credit optimization first attempts to originate the requested loan through standard practices, but if the consumer is denied, the system for credit optimization analyzes the consumer's financial situation and, if possible, makes recommendations that, if accepted, will move the consumer's financial state into one in which the loan will likely be approved. Although many alternatives are anticipated for use by the system for credit optimization, a few examples are looking for refinance options to reduce existing debt, looking to existing assets for equity, looking to see if there are co-borrowers and whether one of the co-borrowers is in a better financial state and is able to obtain the loan without the other co-borrower, etc.

In another embodiment, a method of credit optimization is disclosed including obtaining data regarding the desired loan, the data including a loan amount, obtaining financial data for the consumer, and obtaining at least one credit report for the consumer. From these, a debt-to-income ratio is calculated for the consumer from the financial data and the data regarding the desired loan. If the debt-to-income ratio is less than a maximum debt-to-income ratio, the desired loan is approved without requiring alternative solutions and completing. If the debt-to-income ratio is not less than a maximum debt-to-income ratio, searching is performed to find at least one alternative solution that will reduce the debt-to-income ratio to a value that is less than the maximum debt-to-income ratio. If after searching, the debt-to-income ratio is a value that is not less than the maximum debt-to-income ratio, the desired loan is rejected and the method completes. Otherwise, the alternative solutions are proposed to the consumer and if the consumer accepts the alternative solutions, the desired loan (and alternative solutions) are approved and the method completes. If the consumer does not accept the alternative solutions, the desired loan is denied.

In another embodiment, a system for credit optimization is disclosed including a computer and a plurality of data sources that are accessible by the computer. The plurality of data sources include at least a credit reporting agency and a lender (e.g. loan rates, etc.). Software that runs on the computer inputs and stores financial data regarding the consumer from a user interface and/or from any or all data sources. The software that runs on the computer inputs and stores data regarding a desired loan. The data regarding a desired loan includes a loan amount. The software that runs on the computer calculates a debt-to-income ratio for the consumer from the financial data and the data regarding the desired loan and determines if the debt-to-income ratio for the consumer is less than a maximum debt-to-income ratio. If less, the software provides approval for the desired loan without requiring alternative solutions and ends. Otherwise, (debt-to-income ratio for the consumer is not less than a maximum debt-to-income ratio), the software searches for at least one alternative solution that will reduce the debt-to-income ratio to a value that is less than the maximum debt-to-income ratio. If, after the search, the debt-to-income ratio is a value that is not less than the maximum debt-to-income ratio, the software rejects the desired loan and ends. Otherwise, the software proposes the alternative solutions to the consumer and if the consumer accepts the alternative solutions, the software approves the desired loan and ends. Otherwise (the consumer does not accept the alternative solutions), the software denies the desired loan and ends.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system for credit optimization.

FIG. 2 illustrates a schematic view of a computer as used by the system for credit optimization.

FIGS. 3-6 illustrate exemplary data input user interfaces of the system for credit optimization.

FIGS. 7 and 8 illustrate data collected or entered and used by the system for credit optimization.

FIG. 9 illustrates a list of sample data related to a desired loan in the system for credit optimization.

FIG. 10 illustrates a sample program flow for prior systems for originating a loan.

FIG. 11 illustrates a simplified program flow for the system for credit optimization.

FIGS. 12 through 21 illustrate detailed sample program flows for the system for credit optimization.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the term, “primary loan” represents any loan that might be sought such as an automobile loan, mortgage, personal loan, etc. Throughout this description, the term “consumer” refers to a person or persons that are seeking a loan or wish to improve their financial situation. The term “lender” refers to the financial institution that may or may not provide the primary loan.

In some embodiments, the described system for credit optimization is made directly available to the consumer (e.g. through Internet access) and the consumer becomes the user of the system for credit optimization. In some embodiments, the described system for credit optimization is operated by a financial institution that offers such loans or by a third party. When operated by a third party, the system for credit optimization will perform the same or similar steps, except it will seek a financial institution that matches the loan requested by the consumer.

Throughout this description, various types of loans are described as examples (e.g. vehicle loans, student loans, mortgages) and these are meant to be examples as there is no limitation on the types of loans that the consumer currently has outstanding, nor the types of loans sought by the consumer.

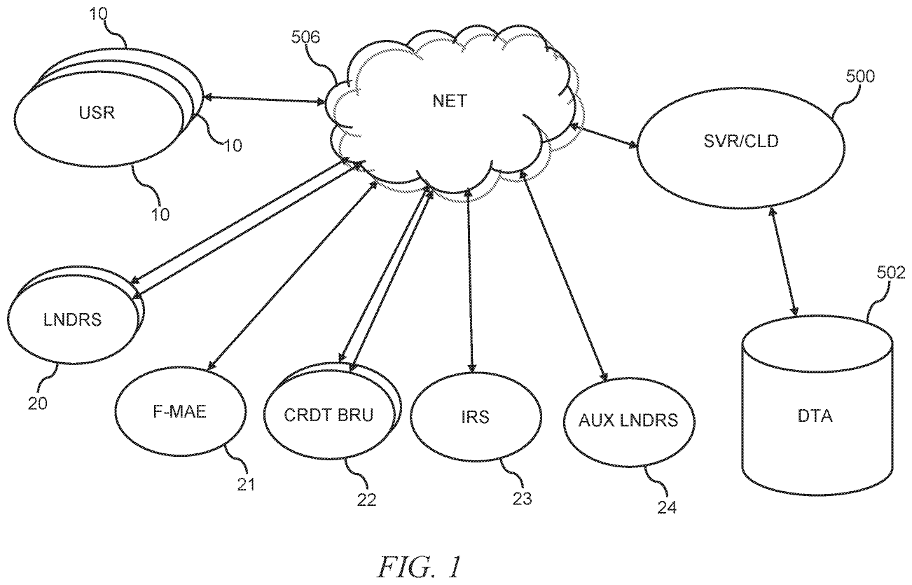

Referring to FIG. 1 illustrates a data connection diagram of the system for credit optimization. In this example, one or more user devices 10 communicate through the wide area network 506 (e.g. the Internet) to a server computer 500. That which is shown in FIG. 1 is but an exemplary connection layout and is in no way limiting as other networking configurations are anticipated as known in the art.

The server computer 500 has access to data storage 502. The server computer 500 transacts with the user devices 10 through the network 506 to present menus to/on the user devices 10, obtain inputs from the user devices 10, and provide data to the user devices 10. In some embodiments, login credentials (e.g., passwords, pins, secret codes) are stored local to the user devices 10; while in other embodiments, login credentials are stored in a data storage 502 (preferably in a secured area) requiring a connection to login.

The server 500 has access to one or more data sources 20/21/22/23/24 for obtaining information that is used to determine approval and/or alternatives for obtaining the desired primary loan. In this example, the one or more data sources 20/21/22/23/24 include one or more lenders 20 (note that in some embodiments, the server 500 is part of a lender 20 and therefore, connected locally). In this example, the one or more data sources 20/21/22/23/24 also include Fannie Mae 21, one or more credit bureaus 22, a taxation authority 23 (shown as the IRS, though different in other countries), and auxiliary lenders 24. An auxiliary lender 24 is, for example, a lender that may provide an ancillary loan such as a home equity loan, automobile loan, or student loan that may be needed in order for the consumer to obtain the primary loan.

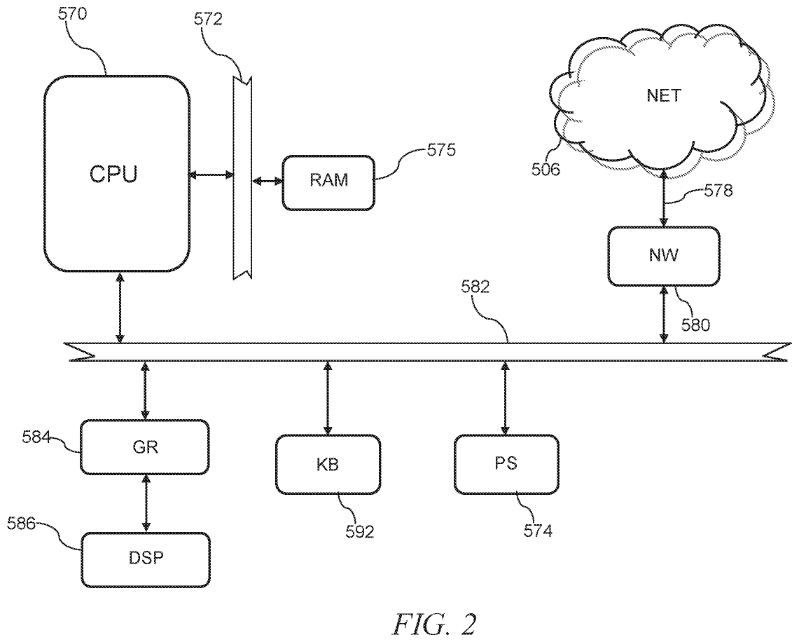

Referring to FIG. 2, a schematic view of a typical computer system (e.g., server 500 or user devices 10) is shown. The example computer system 500 represents a typical computer system used for back-end processing, calculating financial models, generating reports, displaying data, etc. This exemplary computer system is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display image on the display 586. The keyboard interface 592 provides navigation, data entry, and selection features.

In general, some portion of the persistent memory 574 is used to store programs, executable code, data, contacts, and other data, etc.

The peripherals are examples and other devices are known in the industry such as speakers, microphones, USB interfaces, Bluetooth transceivers, Wi-Fi transceivers, image sensors, temperature sensors, etc., the details of which are not shown for brevity and clarity reasons.

In FIG. 1, the multiple data sources 20/21/22/23/24 as shown connected to the server 500 through the network 506. The type of connection is not limiting and can be through the network 506, through any form of data communication, including data transfer by bulk means such as magnetic tape, disk, drive, etc. Any number of data sources 20/21/22/23/24 are anticipated from public agencies or from private companies. Any or all data sources 20/21/22/23/24 are anticipated including any of the following, but not limited to the following: banks, savings and loan associations, credit unions, credit bureaus, tax organizations, court records, judgement data, lenders, etc.

Throughout this document, the term “user” refers to the person or persons operating the system for credit optimization and, in some embodiments, the user is also the consumer.

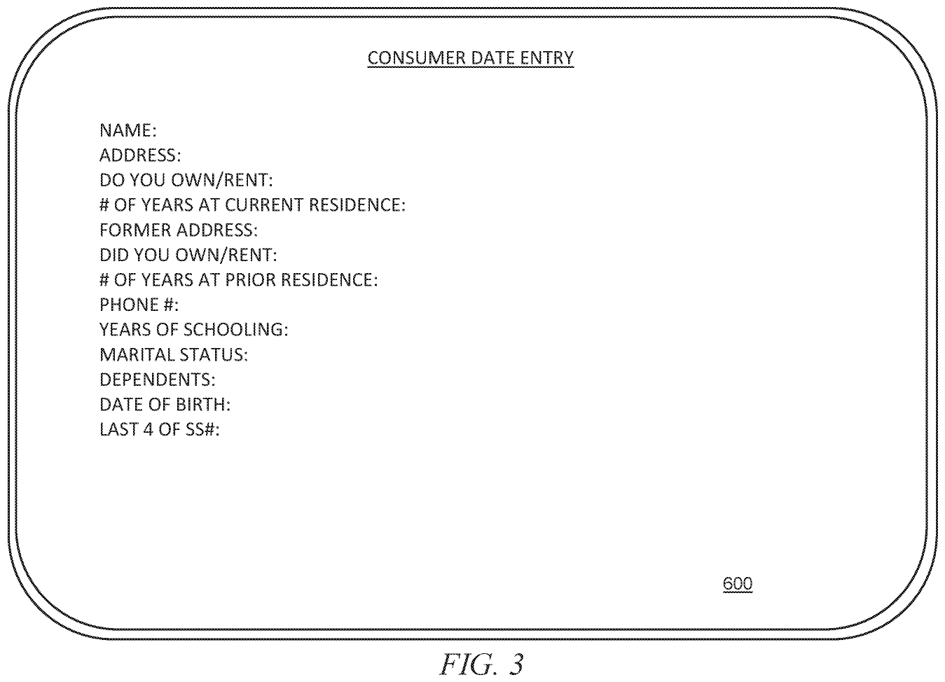

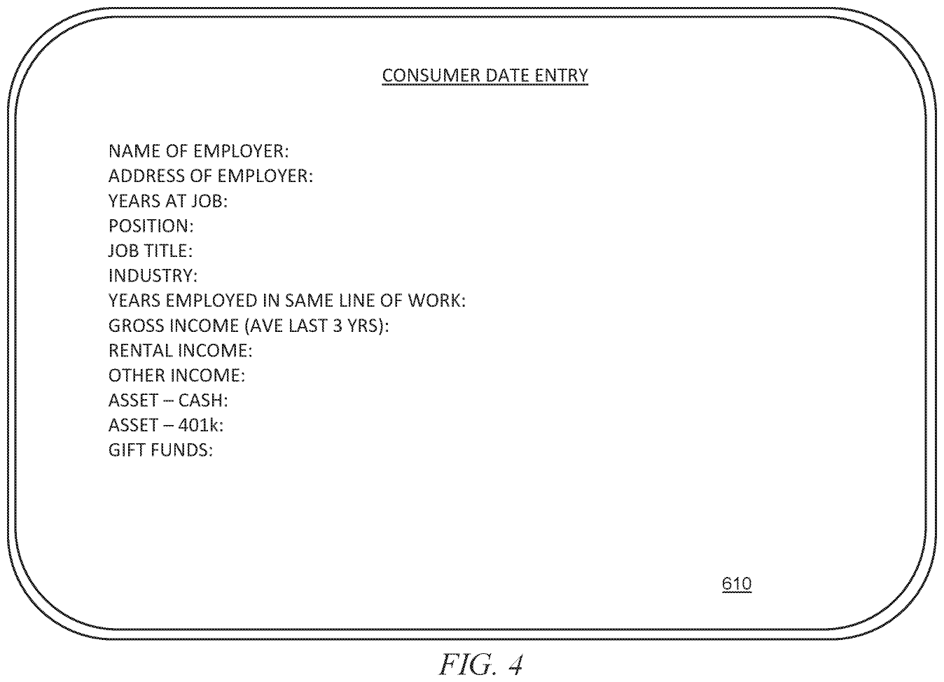

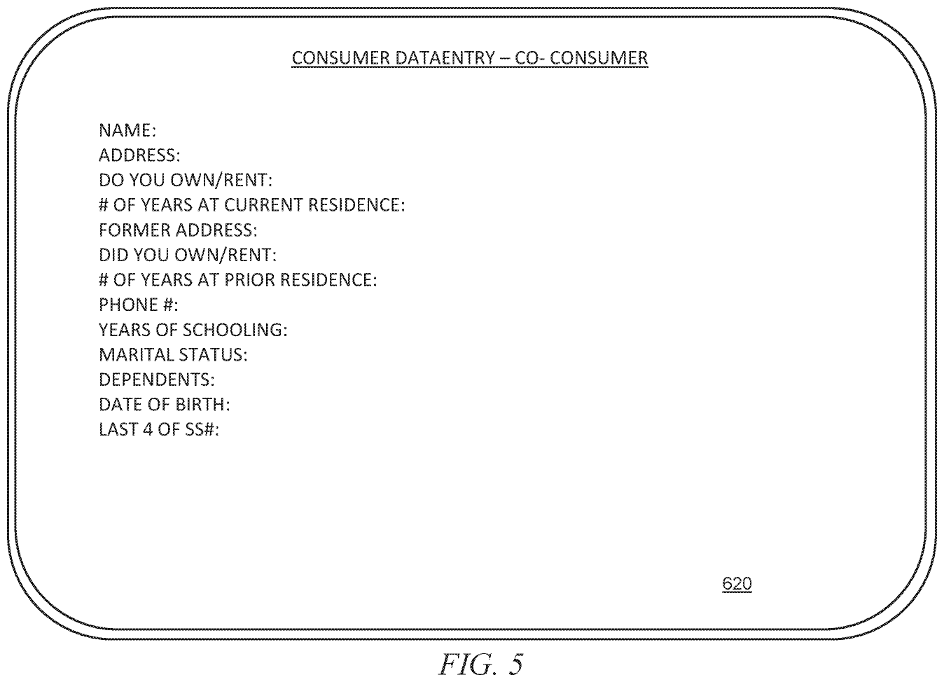

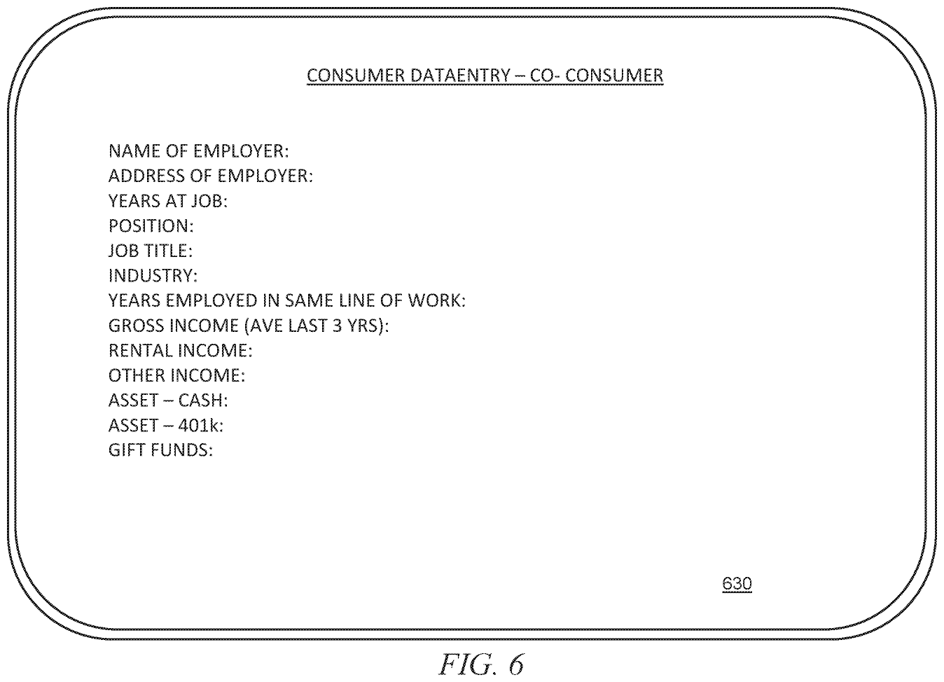

Referring to FIGS. 3-6, sample data input user interfaces 600/610/620/630 of the system for credit optimization is shown. In FIGS. 3-4, data is requested from the consumer (e.g. borrower) while in FIGS. 5-6, data is requested from a co-borrower if one exists. Although only two consumers are shown, the system for originating loans is not limited to any number of consumers as long as there is one consumer. In addition, it is anticipated that in some embodiments, the consumer is an organization instead of a person and, if the consumer is an organization, then certain data changes are made. For example, instead of social security number, a tax ID is obtained.

In some embodiments, imaging and character recognition are used to obtain the data from the consumer. For example, an image is captured of the consumer's most recent tax returns, credit card statements, bank statements, loan agreements, etc., and the image is analyzed using character recognition and intelligence related to determining what each set of numbers represents. For example, capturing an image of the consumer's tax return and recognizing the 10 digit number that is a social security number and line 37 represents the consumer's gross income . . . . In another example, capturing an image of a consumer's loan agreement for a vehicle loan then character recognizing and analyzing such will proved the principle amount, date of first payment, date of last payment, monthly payment amount and interest rate . . . .

In some embodiments, key data inputs are used to obtain complete financial and personal information regarding the consumer. For example, having all or part of a social security number (e.g. last 4), home address, name, and date of birth, authorized users are able to access the consumer's credit score and credit report including debts.

The system for credit optimization utilizes data provided from the consumer(s) to determine if it is possible to obtain a loan based upon the consumer(s) financial status and any recommended financial changes.

The user interfaces 600/610/620/630 shown in FIGS. 3-6 are simplified for clarity and brevity reasons. It is fully anticipated that any or all inputs be made in any way known in the industry using any input device and user interface arrangement, including paper that is later scanned and recognized.

It is also fully anticipated that, in some embodiments, more or less data is entered into the system for credit optimization, as it is fully anticipated that more or less data is required to originate the loan and/or some data is automatically obtained from the data sources 20/21/22/23/24. For example, in the user interface 610 of FIG. 4, gross income is requested, but in the United States, having the consumer's social security number (or last 4 digits of the consumer's social security number), name, and address, the consumer's gross income is obtainable from the taxation authority 23 of the United States, e.g. the, IRS.

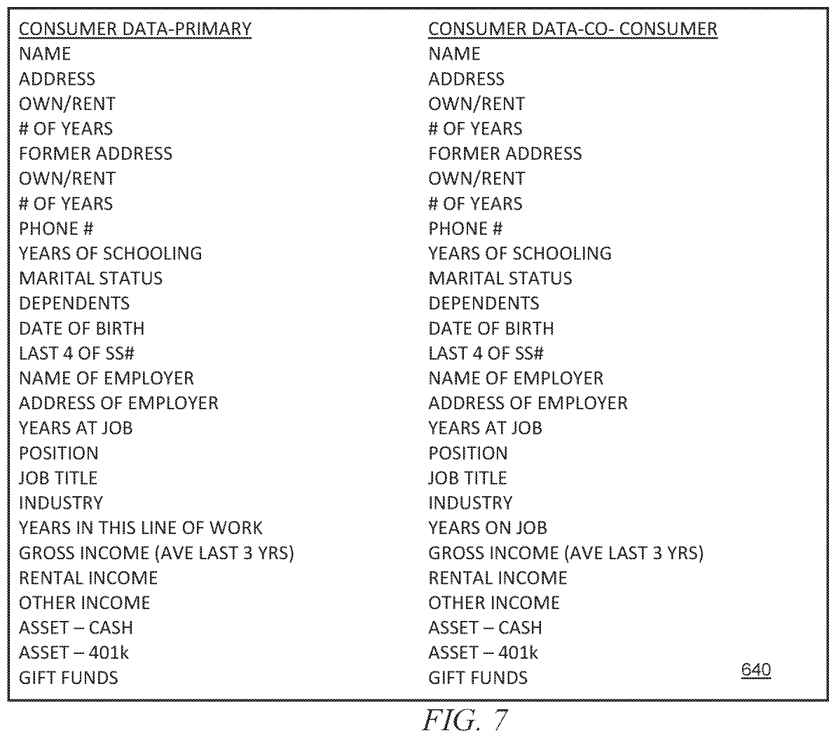

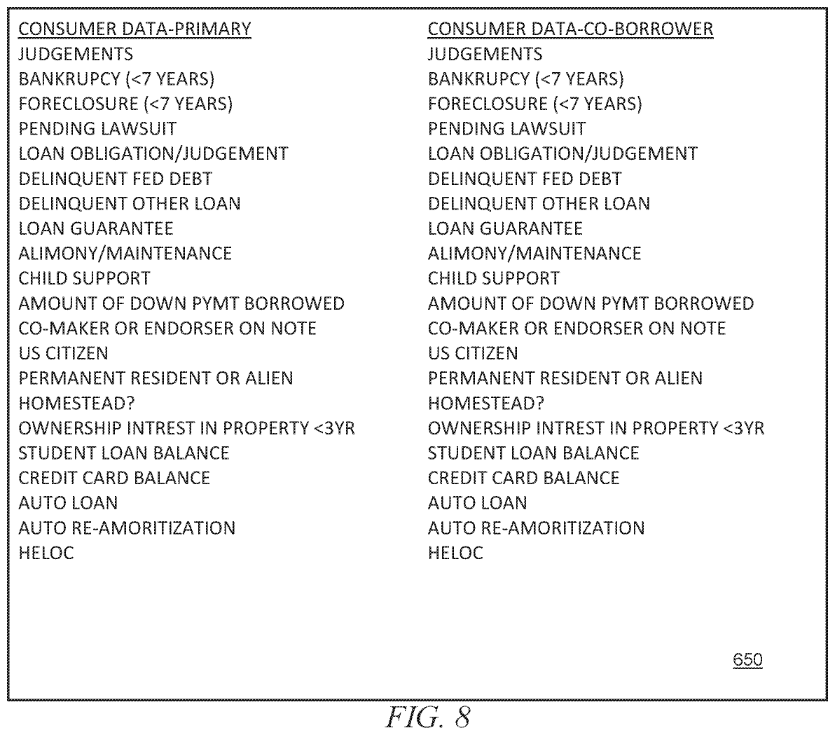

Referring now to FIGS. 7 and 8, a list of data 640/650 that is collected/obtained by the system for credit optimization is shown. The list of data that is collected/obtained 640/650 includes data which is collected (e.g. through data entry) and data that is obtained (e.g. from any of the data sources 20/21/22/23/24).

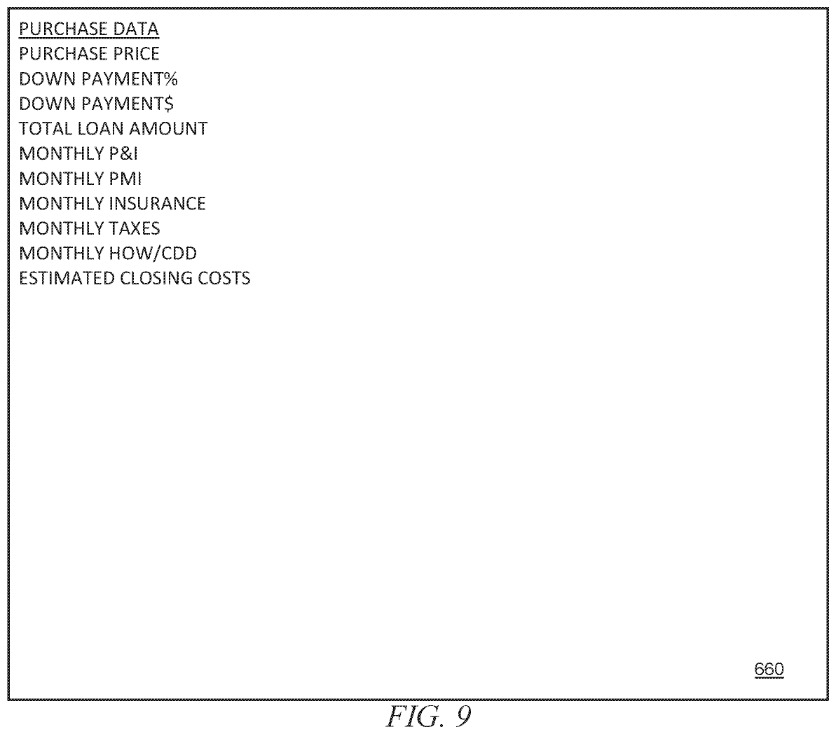

Referring now to FIG. 9, a list of data 660 related to the primary loan is shown. The list of data 660 related to the primary loan includes data which is collected (e.g. through data entry) and data that is obtained (e.g. from any of the data sources 20/21/22/23/24) regarding the primary loan. For example, if the primary loan is a mortgage, then the data 660 related to the primary loan includes the purchase price of the home, the down payment, insurance costs, taxes, homeowner association costs, etc. From these and lender information, the loan amount, monthly principle and interest, and closing costs are derived.

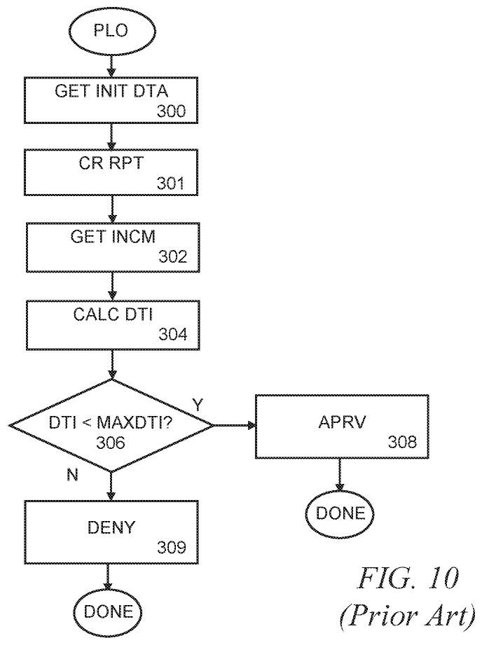

Referring to FIG. 10, a sample program flow of a prior system for loan origination is shown. In the past, the loan origination process included obtaining data 300 from the consumer(s), obtaining one or more credit reports 301 for the consumer(s), and obtaining the consumer(s) income 302. Next, the financial institution calculates 304 a debt-to-income ratio. The debt-to-income ratio is a well-known measurement of a consumer's ability to pay back a loan that is widely used in today's lending practices. For example, if a consumer's debt-to-income ratio is over 100%, there would be no way for the consumer to pay back the primary loan, as the loan payments would require more money than the consumer earns. Acceptable debt-to-income ratios vary by financial institution and government institutions. For example, Fannie Mae will not approve a primary loan if the consumer's debt-to-income ratio is greater than 43% while some financial institutions will approve a primary loan if the consumer's debt-to-income ratio is greater, for example as high as 46%, etc. In prior origination systems, a test 306 is made to determine if the consumer's debt-to-income ratio is less than the maximum allowed debt-to-income ratio and if the consumer's debt-to-income ratio is less than the maximum allowed debt-to-income ratio, the primary loan is approved 308. If the consumer's debt-to-income ratio is not less than the maximum allowed debt-to-income ratio (greater than or equal to), the primary loan is denied 309.

In system for credit optimization of the prior art, no further analysis was performed to see if there exist steps that will improve the consumer's debt-to-income ratio. For example, if the maximum allowed debt-to-income ratio is 43% and the consumer's debt-to-income ratio is 43.5% but the consumer has an automobile loan on which they are paying a high percentage, refinancing of the automobile loan to a lower percentage and/or spread out over a longer period of time will reduce the consumer's monthly car loan payments and, hence reduce the consumer's debt-to-income ratio, hopefully to a debt-to-income ratio that is lower than the maximum allowed debt-to-income ratio (43%). As will be shown, the system for credit optimization explores many alternative methods for reducing the consumer's debt-to-income ratio to a satisfactory debt-to-income ratio, at which, the primary loan will be possible.

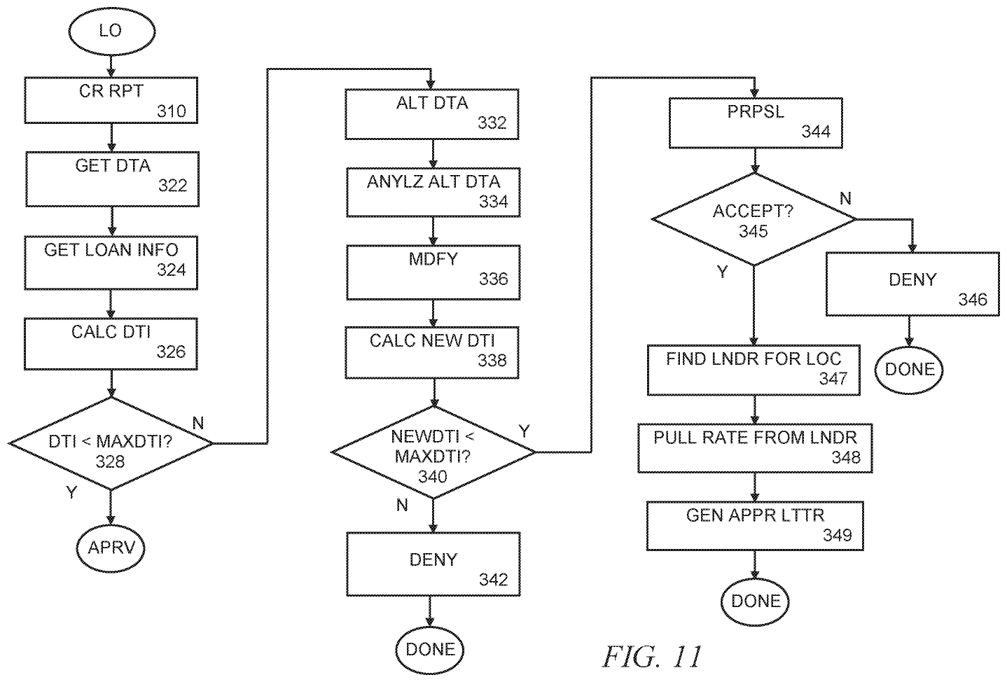

Referring to FIGS. 11-21, sample program flow charts for the system for loan origination are shown. The high-level flow charts of FIGS. 11-21 are for illustration purposes and are described in brief form to convey the overall operation of the system for loan origination. One skilled in the art of programing and, especially, artificial intelligence, without undue experimentation and using this description, would have little difficulty developing the described system for loan origination.

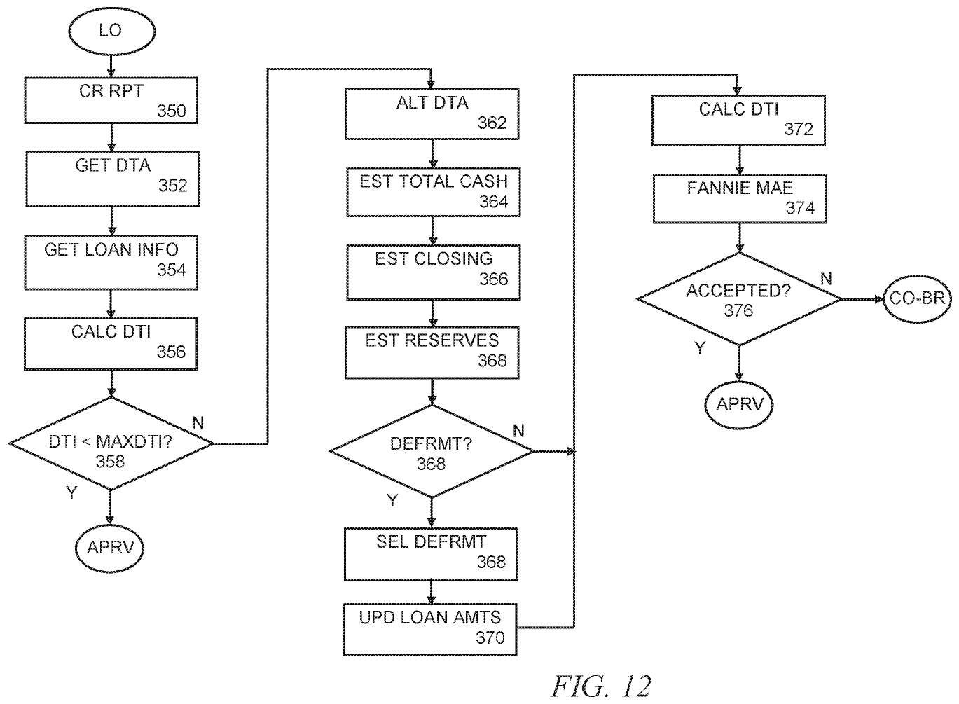

In FIG. 11, a simplified program flow of a process for originating loans is shown. This simplified flow is provided as an overview, as starting with FIG. 12, a more in-depth flow is shown. To start the loan origination, credit report is obtained 310 and data is gathered 322 regarding the consumer. Note that the data that is gathered is similar or the same as the data shown in FIGS. 7 and 8, as obtained through any user interface, for example that shown in FIGS. 3-7. Loan information is gathered 324, similar or the same information as shown in FIG. 9.

Note that as stated previously, an example of a home loan, e.g. a mortgage is used in the examples shown. There is no limitation as to the type and purpose of loan that is envisioned to be originated by the disclosed system and method. For example, types of loans include, but are not limited to, vehicle loans, boat loans, personal loans, loans for jewelry, etc.

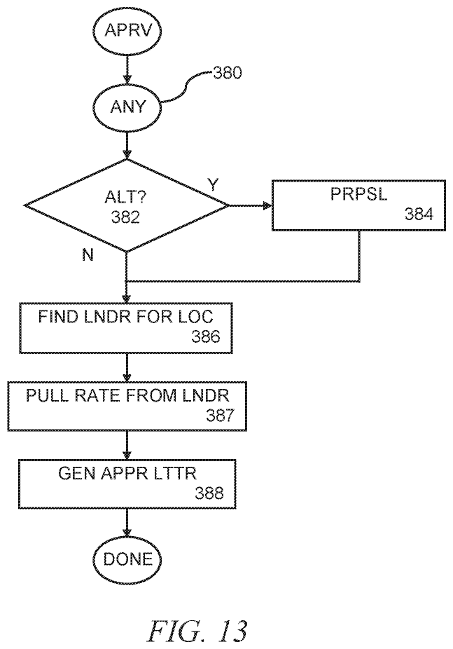

The credit report and other inputs provide data regarding current income(s) of the consumer and current debts, hence payments being made by the consumer. The income is compared to the debts, including the loan information that is gathered 324 and a debt-to-income ratio is calculated 328. The debt-to-income ratio is compared 328 to a maximum allowable debt-to-income ratio. As prior, if the debt-to-income ratio is less than 328 the maximum debt-to-income ratio, the loan is approved (see APRV in FIG. 13). Now, in contrast to prior systems, if the debt-to-income ratio is not less than 328 the maximum debt-to-income ratio, further analysis is performed. New data is obtained 332, if not already obtained and saved (e.g. step 322). The alternate data gathered 332 include details of the consumer's financial status. Note that the alternate data that is gathered 322 is similar or the same as the data shown in FIGS. 7 and 8, as obtained through any user interface, for example that shown in FIGS. 3-7. The alternate data being considered includes details related to entries on the consumer's financial statement that lead to monthly payments (e.g. a vehicle load, student loan . . . ) and to assets owned by the consumer such as cash or equity in a property, etc.

The data related to monthly payments and debts is analyzed 334 to determine if the consumer is able to make any changes that would place them in a better position to obtain the desired loan. For example, if the consumer is currently paying a $20,000.00 vehicle loan over 2 years at 8% and a vehicle loan rate for that amount over 4 years is available at 4%, then the consumer's monthly payments will decrease substantially if the consumer refinances this loan with the new loan parameters, lowering the consumer's debt-to-income ratio.

A new debt-to-income ratio is calculated 338 and the new debt-to-income ratio is compared 340 to the maximum debt-to-income ratio. If the new debt-to-income ratio is still greater than 340 the maximum debt-to-income ratio, the loan is denied 342.

If the new debt-to-income ratio is not greater than 340 the maximum debt-to-income ratio, a proposal is made 344 to the consumer. The consumer must accept the recommendations before the recommendations are implemented. If the consumer rejects the recommendations 345, the loan is denied 346, as the originally calculated debt-to-income ratio was not satisfactory for loan approval.

If the consumer accepts the recommendations 345, a lender that will accept the loan is located 347 (if the system for loan origination supports multiple lenders as it does in some embodiments) and loan rates and terms are obtained 348 from the lender and the loan rates and loan details are set forth in an approval letter 349 that is delivered to the consumer.

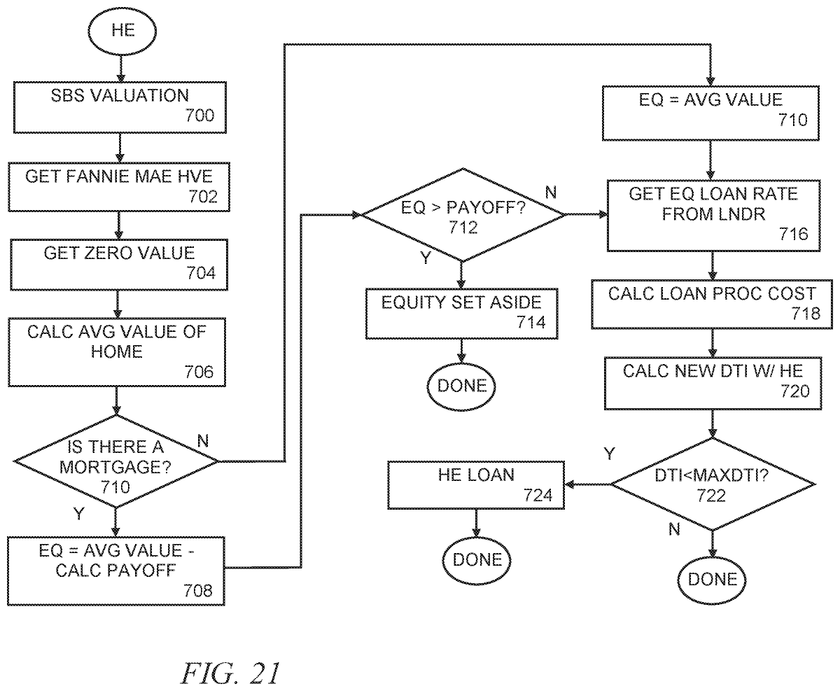

Referring to FIGS. 21-21, a more detailed program flow of a process for originating loans is shown. To start the loan origination, credit report is obtained 350 and data is gathered 352 regarding the consumer. Note that, as above, the data that is gathered is similar or the same as the data shown in FIGS. 7 and 8, as obtained through any user interface, for example that shown in FIGS. 3-7. Loan information is gathered 354, similar or the same information as shown in FIG. 9.

Note that as stated previously, in this program flow, an example of a home loan, e.g. a mortgage is used in the examples shown. There is no limitation as to the type and purpose of loan that is envisioned to be originated by the disclosed system and method. For example, types of loans include, but are not limited to, vehicle loans, boat loans, personal loans, loans for jewelry, etc.

The credit report and other inputs provide data regarding current income(s) of the consumer and current debts, hence payments being made by the consumer. The income is compared to the debts, including the loan information that is gathered 354 and a debt-to-income ratio is calculated 356. The debt-to-income ratio is compared 358 to a maximum allowable debt-to-income ratio. As prior, if the debt-to-income ratio is less than 358 the maximum debt-to-income ratio, the loan is approved (see APRV in FIG. 13). Now, if the debt-to-income ratio is not less than 358 the maximum debt-to-income ratio, further analysis is performed. New data is obtained 362, if not already obtained and saved (e.g. step 352). The alternate data gathered 362 include details of the consumer's financial status. Note that the alternate data that is gathered 362 is similar or the same as the data shown in FIGS. 7 and 8, as obtained through any user interface, for example that shown in FIGS. 3-7. The alternate data being considered includes details related to entries on the consumer's financial statement that lead to monthly payments (e.g. a vehicle load, student loan . . . ) and to assets owned by the consumer such as cash or equity in a property, etc.

Now, the alternate data is analyzed to estimate total cash available 364, closing costs for the loan 366 and estimated reserves 368. Now, if the consumer has the ability to defer a loan 368, a deferment is selected 368 and the loan amounts data is updated 370 to include the reduced amount of monthly loan repayments needed with the reduced amount from the deferment. Note that certain student loans provide for such deferments. A new debt-to-income ratio is calculated and the new debt-to-income ratio is run through the Fannie Mae system 374 to see if Fannie Mae will approve the loan. Note that Fannie Mae is a federal mortgage association in the United States and other similar authorities are anticipated for other countries.

If the new debt-to-income ratio is accepted 376 by Fannie Mae, the loan is approved (see APRV steps in FIG. 13).

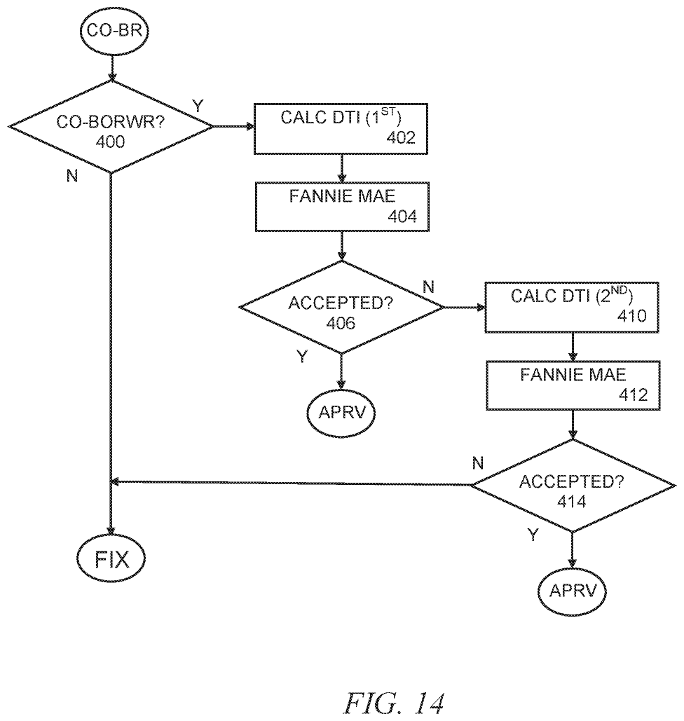

If the new debt-to-income ratio is not accepted 376 by Fannie Mae, further steps are taken to seek loan approval (see CO-BR, FIG. 14).

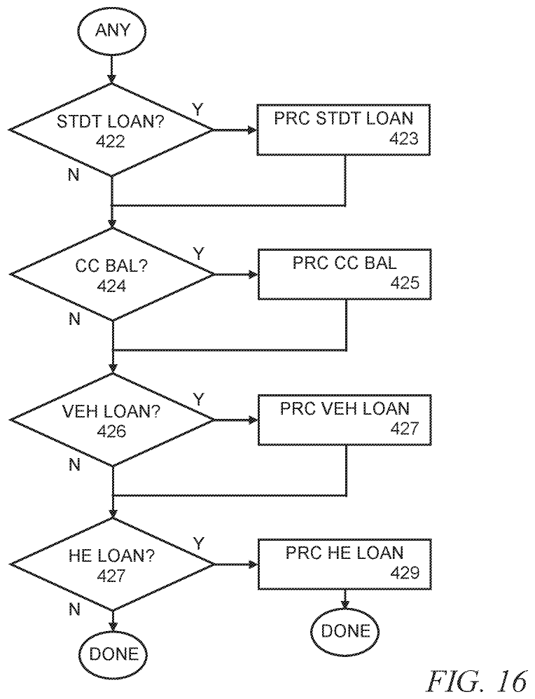

In some embodiments, once an approval is made, further analysis is performed 380 (see ANY FIGS. 16-21) to look for alternative solutions that will reduce the consumer's debt-to-income ratio to an acceptable level. Such solutions are optional and, in some cases, provide improved financial performance to the consumer and improved value to the lender. For example, some alternatives include the consumer refinancing a loan (e.g. a vehicle loan, student loan, etc.) using products offered by the lender. The consumer sees value in that the consumer will pay less for the loan (e.g. lower interest rate, different term, etc.) and the lender will benefit by profits related to servicing or selling the refinanced loan. If any alternative solutions are found 382, then a proposal is made 384 to the consumer. Note that it is not required that the consumer accept the proposals that are made 384, as the loan is already approved and the proposed alternative solutions are not required to obtain the desired loan.

As before, in some embodiments, the system for loan origination processes loans for several lending institutions and, in such embodiments, a lender is located for the approved loan and rates, etc., are pulled from that lender 387 and an approval letter is generated 388.

Now, in FIG. 14 it is determined whether there is a second consumer (e.g. co-borrower 400). When there is a co-borrower, it is possible that the desired loan is possible using only one of the co-borrowers instead of both combined, as one co-borrower often has more income or more debt (payments) than the other co-borrower. Note that FIG. 14 is simplified for two consumers, though it is fully anticipated that more than two consumers exist for a given loan.

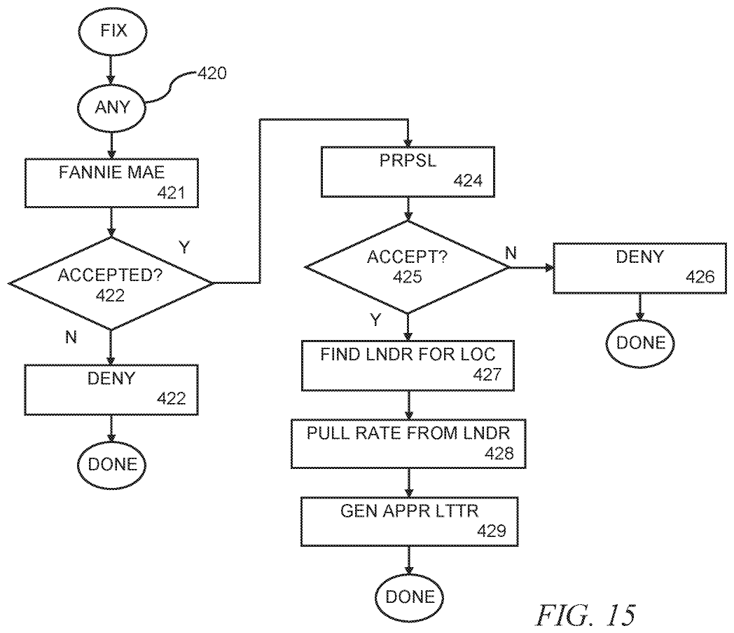

If there are no co-borrowers 400, flow continues with looking for fixes (see FIX of FIG. 15).

If there are co-borrowers 400, then the debt to income level is calculated for the first co-borrower 402 and that is run through the Fannie Mae system 404 (or other system as noted above). If the debt to income level for the first borrower is sufficient and accepted by Fannie Mae 406, then the loan is approved based upon the first co-borrower and the approval runs (see APRV in FIG. 13). If the debt to income level for the first borrower is not sufficient and, hence, not accepted by Fannie Mae 406, then the debt to income level is calculated for the second co-borrower 410 and that is run through the Fannie Mae system 412 (or other system as noted above). If the debt to income level for the second borrower is sufficient and accepted by Fannie Mae 414, then the loan is approved based upon the second co-consumer and the approval runs (see APRV in FIG. 13). If the debt to income level for the second consumer is not sufficient and, hence, not accepted by Fannie Mae 414, flow continues with looking for fixes (see FIX of FIG. 15).

In FIX, further analysis is performed 420 (see ANY FIGS. 16-21) to look for alternative solutions that will reduce the consumer's debt-to-income ratio to an acceptable level. Such solutions provide improved financial performance to the consumer and, potentially, improved value to the lender. For example, some alternatives include the consumer refinancing a loan (e.g. a vehicle loan, student loan, etc.) using products offered by the lender. The consumer sees value in that the consumer will pay less for the loan (e.g. lower interest rate, different term, etc.) and the lender will benefit by profits related to servicing or selling the refinanced loan. If any alternative solutions are found 420, then the new debt-to-income ratio is processed through Fannie Mae (or equivalent) 421. If the alternative solutions are not accepted by Fannie Mae (or equivalent) 422, the loan is denied. If the alternative solutions are accepted by Fannie Mae (or equivalent) 422, the proposed alternative solutions are presented to the consumer in a proposal 424 and the consumer is asked to accept the proposed alternate solutions. If the consumer does not accept the proposed alternate solutions 425, then the loan is denied 425 as there are no acceptable solutions.

If the consumer accepts the proposed alternate solutions 425, then as before, in some embodiments, the system for loan origination processes loans for several lending institutions and, in such embodiments, a lender is located 427 for the approved loan and rates, etc., are pulled 428 from that lender and an approval letter is generated 429.

In FIG. 16, the process of determining if there are any alternative solutions (ANY) is performed. Multiple alternative solutions are sought (searched) to reduce the consumer's debt-to-income ratio to an acceptable level. In the examples shown in FIGS. 16-21, the consumer's student loans, credit card balances, vehicle loans, and home equity are analyzed to find alternative solutions, though it is fully anticipated that other financial situations are equally analyzed. For example, in some embodiments, other loans are analyzed such as watercraft loans, personal loans, etc.

Although shown sequential, there is no required order for this search process. For example, in some embodiments, each alternative path is traversed in parallel. In some embodiments, if an alternative is found regarding one search (e.g. a student loan), there is no need to search for other alternative solutions. Further, even though shown having all searches for solutions performed, even if an earlier search has a workable alternative solution, in some embodiments, once a workable alternative solution is found, that alternative is reported and no further searching is performed.

In the examples of looking for alternative solutions, it is fully anticipated that, in some embodiments, more or less searches are made for alternative solutions are made. For example, some lending institutions are not interested in refinancing a student loan and, therefore, no alternative solution regarding a student loan is sought. As another example, the examples shown look for vehicle loans (e.g. car loan, motorcycle loan) while it is fully anticipated that any type of loan is fair game for analysis, including, but not limited to, a personal loan, a watercraft loan, a jewelry loan, a loan on a second home, etc.

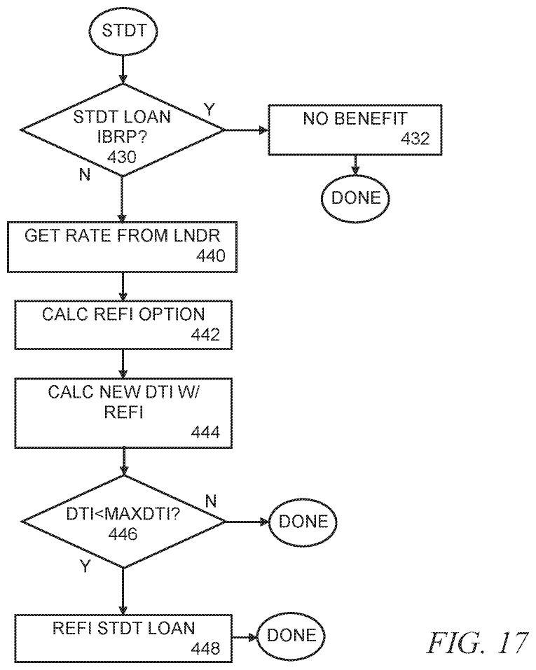

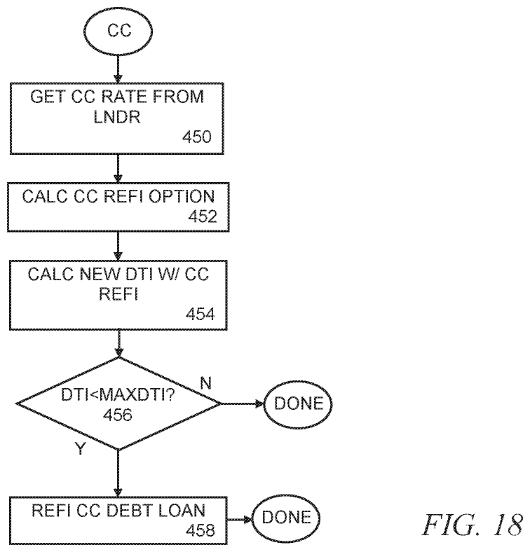

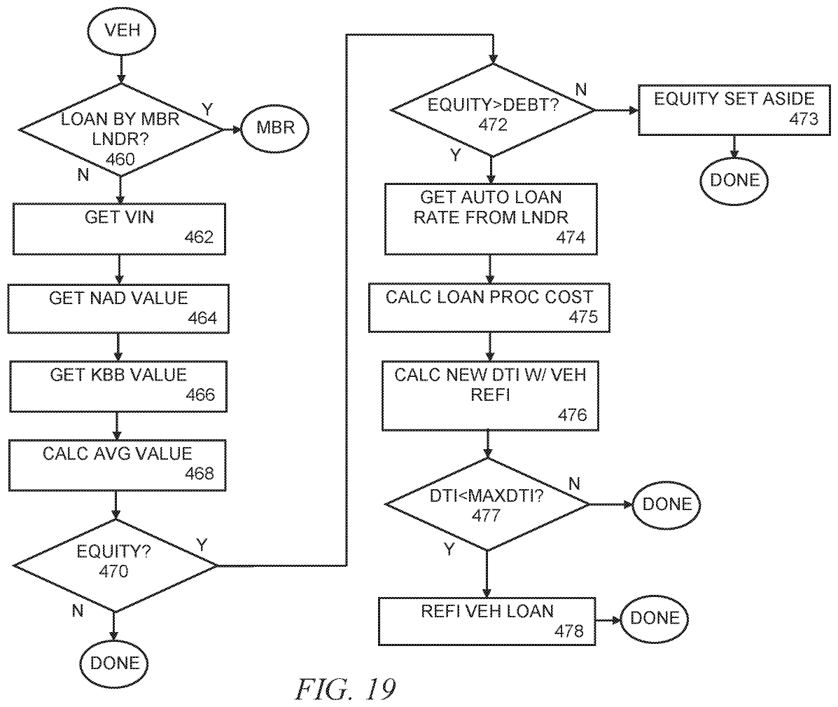

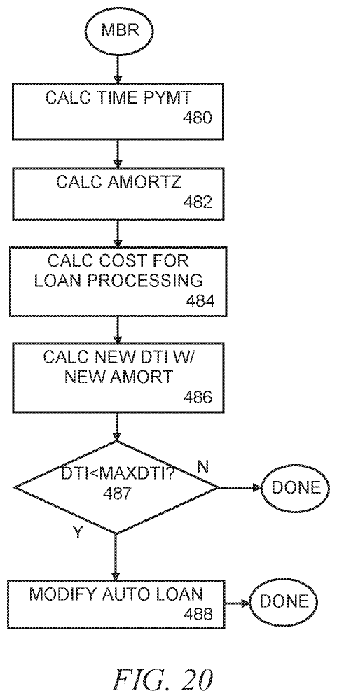

In the example shown in FIG. 16, it is determined if there is a student loan 422. If there is a student loan 422, the student loan is processed 423 (see FIG. 17). Next (or at the same time) it is determined if there is any credit card balance (debt) 424. If there is any credit card debt 424, the credit card debt is processed 425 (see FIG. 18). Next (or at the same time) it is determined if there is a vehicle loan 426. If there is a vehicle loan 426 (or several), the vehicle loan(s) is/are processed 425 (see FIGS. 19 and 20). Next (or at the same time) it is determined if there is any home equity 427 that can be used to improve the consumer's debt-to-income ratio. If there is any home equity 427, the home equity is processed 429 (see FIG. 21).

In the example shown in FIG. 17, it has been determined that there is a student loan 422. The student loan is processed by first checking to see if the student loan is indexed to the consumer's earnings 430. If the student loan is indexed to the consumer's earnings 430 (income-based repayment), no benefit can be obtained 432 from refinancing the student loan and no solution is recorded.

If the student loan is not indexed to the consumer's earnings 430, a refinance loan rate is obtained from one or more lenders 440 and a calculation is made 442 to determine the effect of the refinanced student loan as well as a calculation 444 of a new debt-to-income ratio taking in to consideration the refinanced student loan. If the new debt-to-income ratio is not less than the maximum allowed debt-to-income ratio 446, no benefit can be obtained from refinancing the student loan and no solution is recorded. If the new debt-to-income ratio is less than the maximum allowed debt-to-income ratio 446, a recommendation to refinance this student loan 448 is recorded. Note that it is fully anticipated that there are multiple student loans and each student loan will be considered either separately (e.g. individual refinanced student loans) or combined in any order into one or more refinanced student loans.

In the example shown in FIG. 18, it has been determined that there is some credit card balance (debt) 424. Credit card debt usually carries high interest rates that result in high monthly payments. The credit card debt is processed by finding a new credit card rate from a lender 450. For example, some lenders have credit cards that will accept balance transfers at a lower interest rate than the consumer's existing credit card(s) or some lenders will map the credit card debt into a different type of loan, etc. A calculation is made 453 to determine the effect of the refinanced credit card as well as a calculation 454 of a new debt-to-income ratio taking in to consideration the refinanced credit card debt. If the new debt-to-income ratio is not less than the maximum allowed debt-to-income ratio 456, no benefit can be obtained from refinancing the credit card debt and no solution is recorded. If the new debt-to-income ratio is less than the maximum allowed debt-to-income ratio 456, a recommendation to refinance some or all of the credit card debt 458 is recorded.

In the example shown in FIGS. 19 and 20, it has been determined that there is at least one vehicle loan 426. A vehicle loan is typically for a motor vehicle such as a car, truck, motorcycle, etc. It is also anticipated that other vehicles be reviewed such as boats, airplanes, etc., though different tools are available to ascertain the current value of such. For example, instead of using a Kelly Blue Book value for an auto, a boat trader value is used for a boat. Again, in countries other than the United States, it is fully anticipated that other service provide similar information regarding the current value of such vehicles, etc.

The vehicle loan(s) is/are processed first by determining if the existing vehicle loan was made by a member lending institution 460 (or the lending institution that is running the system for credit optimization). If the existing vehicle loan was made by a member lending institution 460, the vehicle loan is processed differently as in FIG. 20.

If the existing vehicle loan was not made by a member lending institution 460, the vehicle identification number is obtained 462 (e.g. from the title or from the original loan). The vehicle identification number (VIN) is useful in determining what options are included with the vehicle, etc. If not available, the value of the vehicle can be estimated, but requires further input. Also, the condition of the vehicle must be estimated, as a poorly maintained vehicle is worth less than a well maintained vehicle.

Now, the value of the vehicle is determined 464/466. Note that two valuation systems are consulted in this example, National Auto Dealers (NAD) 464 and Kelly Blue Book (KBB) 466, though there is no restriction as to the service that is consulted or the number of services that are consulted, as such varies from country to country, etc. The valuation(s) are then averaged 468 and it is determined if there is equity 470 in the vehicle (e.g. the average value calculated 468 is greater than the current vehicle loan). If there is no equity in the vehicle 470, no alternative is reported and this search is done.

If there is equity in the vehicle 470, equity set aside 473 is possible. In this, the member lender will allow xxxx

If the lender is not a member (or the originator), an auto loan rate is obtained from a lender 474 and the loan processing costs are calculated 475. Both are used to calculate a new debt-to-income ratio 476 related to the vehicle refinancing. If the new debt-to-income ratio is not less than the maximum debt-to-income ratio 476, refinancing of the vehicle does not help and this search is done. If the new debt-to-income ratio is less than the maximum debt-to-income ratio 476, a recommendation to refinance the vehicle is recorded 478.

If the lender is a member (or the loan originator), it is in the lender's interest to amortize the vehicle loan over a different time period, keeping all other terms of the vehicle loan the same. For example, if the value of the vehicle is determined to be $25,000.00 and the amount owed is $20,000.00, many lenders allow re-amortization allowing the payments to be spread out over a different time period or allowing for a one-time payment that will reduce the monthly payments. Without such a feature, paying extra principle would not change the monthly payments, it would only shorten the number of payments and make payoff occur earlier.

A new time payment of the loan is calculated 480, the amortization is calculated 482 and the cost for processing the loan is calculated 484. These are used to calculate a new debt-to-income ratio 487 with the new amortization schedule. If the new debt-to-income ratio is not less than the maximum debt-to-income ratio 487, amortization of the vehicle over a new period of time does not help and this search is done. If the new debt-to-income ratio is less than the maximum debt-to-income ratio 487, a recommendation to modify the amortization of the loan on the vehicle is recorded 488.

In the example shown in FIG. 21, it has been determined that there is at least some home equity 427 that can be used to improve the consumer's debt-to-income ratio. The home equity is processed by obtaining one or more valuations for the property. For example, in the United States, a SBS valuation of the home is obtained 700, a Fannie Mae valuation of the home is obtained 702 (e.g. using the Fannie Mae home value explorer—HVE), and a Vero value of the home 704. In this example, an average value of the home is calculated 706. If there is no mortgage 710, then the equity equals this average value 710.

If there is a mortgage 710, then the equity equals this average value minus a calculated payoff for the mortgage 708 and a test 712 is made to determine if the equity is greater than the amount which is required to pay off the mortgage. If the test 712 indicates that the equity is greater than the amount which is required to pay off the mortgage, then the recommendation is for equity set aside 714. If there is no mortgage 710 or the test 712 indicates that the equity is not greater than the amount which is required to pay off the mortgage, then a home equity loan rate is obtained from a lender 716 and the loan processing costs are calculated 718 and a new debt-to-income ratio is calculated 720 including the additional payments for the home equity loan, but applying the loan amount to other loans or to the down payment, etc. For example, if the consumer owns a home that is worth $220,000.00 and they owe $150,000.00, then there is roughly $70,000.00 in equity that the consumer can take out as a home equity loan and use the cash to pay off or pay down credit card debt, pay off or pay down other loans, and/or pay off or pay down other debt such as back taxes.

If the new debt-to-income ratio is less than the maximum debt-to-income ratio 722, a recommendation to obtain the home equity loan is recorded 724. As an example, the proceeds from the home equity loan are used for paying off or paying down credit card debt, paying off or paying down a loan (e.g. auto loan), etc.

The above described invention and all equivalents are understood to be used by a lender (e.g. a certain bank uses the system to originate loans), by a third party that originates loans for several lenders, or as a tool that is used by the consumer directly (the consumer becomes the user of the system for credit optimization). Compensation from usage of the tool varies. For example, if used by a lender, compensation is provided as a percentage of loans that result from issues solved by the system for loan origination. If used by a third party, the lender that is used compensates the third party and the third party either pays a flat monthly fee for usage of the system for loan origination or pays a percentage of what is earned from the lenders. When used by the consumer (e.g. internet based), in some embodiments, compensation is derived from advertisements (e.g. for homeowners insurance, title insurance, etc.) and/or compensation is provided from preferred lenders that provide the desired loan and/or alternative solutions (e.g. a reduced rate vehicle loan). When used directly by the consumer, the consumer either pays a fee, and/or income is derived from advertising.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of credit optimization, the method comprising:
obtaining data regarding the desired loan, the data including a loan amount;
obtaining financial data for a consumer;
obtaining at least one credit report for the consumer;
calculating a debt-to-income ratio for the consumer from the financial data and the data regarding the desired loan;
if the debt-to-income ratio is less than a maximum debt-to-income ratio, approving the desired loan without requiring alternative solutions and completing;
if the debt-to-income ratio is not less than the maximum debt-to-income ratio, searching for at least one alternative solution that will reduce the debt-to-income ratio to a value that is less than the maximum debt-to-income ratio, and if after searching the debt-to-income ratio is the value that is not less than the maximum debt-to-income ratio, rejecting the desired loan and completing; and
proposing the alternative solutions to the consumer;
if the consumer accepts the alternative solutions, approve the desired loan and completing; and
if the consumer rejects the alternative solutions, denying the desired loan.

2. The method of claim 1, wherein the step of approving the desired loan without requiring alternative solutions further comprises searching for at least one alternative solution and proposing the at least one alternative solution to the consumer.

3. The method of claim 1, wherein the step of searching for the at least one alternative solution comprises analyzing credit card debt and suggesting refinancing the credit card debt with terms that will reduce a monthly payment.

4. The method of claim 1, wherein the step of searching for the at least one alternative solution comprises analyzing student loan debt and suggesting refinancing the student loan debt with terms that will reduce a monthly payment.

5. The method of claim 1, wherein the step of searching for the at least one alternative solution comprises analyzing at least one vehicle loan and suggesting refinancing the at least one vehicle loan with terms that will reduce a monthly payment.

6. The method of claim 5, wherein if one vehicle loan of the at least one vehicle loan is from a member lender, suggesting re-amortization of the one vehicle loan with terms that will reduce the monthly payment.

7. The method of claim 1, wherein the step of searching for the at least one alternative solution comprises analyzing an equity in a home owned by the consumer and if there is equity in the home owned by the consumer, suggesting use of the equity to improve the debt-to-income ratio.

8. The method of claim 1, wherein the desired loan is a mortgage.

9. The method of claim 1, wherein the consumer comprises two or more co-consumers.

10. The method of claim 9, wherein the step of searching for the at least one alternative solution comprises separately analyzing the debt-to-income ratio for each of the two or more co-consumers.

11. A system for credit optimization, the system comprising:
a computer;
a plurality of data sources that are accessible by the computer, the plurality of data sources comprising a credit reporting agency and a lender;
software running on the computer receives financial data regarding the consumer from a user interface and stores the financial data and other financial data from any or all data sources;
the software running on the computer receives data regarding the desired loan from a user interface and stores the data regarding the desired loan, the data regarding the desired loan comprising a loan amount;
the software running on the computer calculates a debt-to-income ratio for the consumer from the financial data and the data regarding the desired loan;
the software running on the computer determines if the debt-to-income ratio for the consumer;
if debt-to-income ratio for the consumer is less than a maximum debt-to-income ratio, the software provides approval for the desired loan without requiring alternative solutions and ends;
otherwise, if debt-to-income ratio for the consumer is not less than the maximum debt-to-income ratio, the software searches for at least one alternative solution that will reduce the debt-to-income ratio to a value that is less than the maximum debt-to-income ratio, if, after the search, the debt-to-income ratio is the value that is not less than the maximum debt-to-income ratio, the software rejects the desired loan and ends;
the software proposes the alternative solutions to the consumer;
if the consumer accepts the alternative solutions, the software approves the desired loan and ends; and
if the consumer rejects the alternative solutions, the software denies the desired loan and ends.

12. The system for credit optimization of claim 11, wherein the step of approving the desired loan without requiring alternative solutions further comprises searching for at least one alternative solution and proposing the at least one alternative solution to the consumer.

13. The system for credit optimization of claim 11, wherein the step of searching for the at least one alternative solution comprises analyzing credit card debt and suggesting refinancing the credit card debt with terms that will reduce a monthly payment.

14. The system for credit optimization of claim 11, wherein the step of searching for the at least one alternative solution comprises analyzing student loan debt and suggesting refinancing the student loan debt with terms that will reduce a monthly payment.

15. The system for credit optimization of claim 11, wherein the step of searching for the at least one alternative solution comprises analyzing at least one vehicle loan and suggesting refinancing the at least one vehicle loan with terms that will reduce a monthly payment.

16. The system for credit optimization of claim 15, wherein if the vehicle loan of the at least one vehicle loan is from a member lender, suggesting re-amortization of the vehicle loan with terms that will reduce the monthly payment.

17. The system for credit optimization of claim 11, wherein the step of searching for the at least one alternative solution comprises analyzing an equity in a home owned by the consumer and if there is equity in the home owned by the consumer, suggesting use of the equity to improve the debt-to-income ratio.

18. The system for credit optimization of claim 13, wherein the desired loan is a mortgage.

19. The system for credit optimization of claim 13, wherein the consumer comprises two or more co-consumers.

20. The system for credit optimization of claim 9, wherein the step of searching for the at least one alternative solution comprises separately analyzing the debt-to-income ratio for each of the two or more co-consumers.
